(19) United States
(12) Patent Application Publication
(10) Pub. No.: US 2020/0253412 A1
(43) Pub. Date: Aug. 13, 2020

(54) Pressurized Distilled Spirits and Brewed Beverages Filtration Loop

(71) Applicants: Kimble Adam Klatt, Thousand Oaks, CA (US); James Joseph Fagan, II, Bigfork, MT (US); Johnny Duthie Fagan, Haiku, HI (US)

(72) Inventors: Kimble Adam Klatt, Thousand Oaks, CA (US); James Joseph Fagan, II, Bigfork, MT (US); Johnny Duthie Fagan, Haiku, HI (US)

(21) Appl. No.: 16/734,678

(22) Filed: Jan. 6, 2020

Related U.S. Application Data
(63) Continuation of application No. 62/803,141, filed on Feb. 8, 2019.

(51) Int. Cl. A47J 31/06

(52) U.S. Cl. CPC A47J 31/06

(57) ABSTRACT

Summary. The Technical Field is Filtration. The Problem is limited filtration consisting of gravity fed existing technology which is inefficient. The Solution is to create a process for small Distillers and Brewers to efficiently carbon filter spirits and brewed beverages to enhance taste, color, clarity and reduce alcohol levels, in finished products. Use enables instant variations in carbon capacity during processing and easy exchange of different carbon media between processes. The process provides affordability and flexibility to small operators based on their unique product, timed and controlled by the operator. This pressurized loop includes testing and tasting stations for measurement and quality control, flow controllers and measurement control, all within a loop system for a complete continuous process which does not exist today. With this Closed system, a mixing tank provides limited product. The Open system draws product directly from the operator's equipment.

### CROSS-REFERENCE TO RELATED APPLICATIONS

Not Applicable.

### STATEMENT REGARDING FEDERALLY SPONSORED RESEARCH AND DEVELOPMENT

Not Applicable.

### BACKGROUND OF THE INVENTION

This is our first pro se Patent application; Thank you for your patience. Spirits have been chill filtered at least from the late 14th century. Filtering became common before the 17^{th} century. Coal filtering was widely used in Canada and the USA in the early 19^{th} century. The famous Lincoln County process using maple wood coal, at a thickness of 10 feet, in 1825, is still used by Jack Daniel's. Activated coal filtering was patented in 1901 in Austria and in 1907 in Russia and used in vodka production.

The “Cutting” of distilled spirits, with water, to lower the alcohol level, is a finishing process, and has been a necessity for Public Safety for many years. Distilled spirits can have high levels of alcohol and regulation of those levels are required to ensure a safe product. Gravity feed Carbon filtration, of the final beverage product, “polishes” the spirit and finishes brewed products to improve taste, quality and clarity.

### a. PROBLEMS WITH EXISTING GRAVITY FEED CARBON FILTRATION

i. Slow inefficient filtering quality
ii. High capacity not affordable to Micro Distillers and Brewers of beverages
iii. Ties up production for Distilling and Brewing equipment making it not available for a new production cycle
iv. Real time Spirit and Brewed beverages:
   1. No sample Testing station
   2. No process Flow control and or Measuring meter
   3. No Tasting station
   4. No pressure Loop for continuous filtering process
   5. Non-Exchangeable Carbon filter media
   6. No Carbon filtration capacity instantly increased or decrease
   7. No Sediment filtration
   8. No Temperature Gauge

### b. PRIOR ART

i. In large commercial settings, prior arts are not affordable for the Micro-Distiller and Brewer, nor are they available due to the large required size of equipment.
ii. Small carbon filtration is quite common in smaller operations, but is very slow, being dominated by “Gravity Fed” filtration systems
iii. Small gravity systems have:
   1. No testing capabilities during the filtration process
   2. No flow control during filtration
   3. Carbon Media cannot be changed efficiently
   4. No ability to change carbon filtration capacity instantly
   5. No sediment filtration
   6. No clarity testing capabilities

### c. SUMMARY

The Distilled Spirits and Brewed Beverages Filtration Loop is a pressurized, continuous loop filtering process to lower alcohol to desired levels and to filter distilled spirits and brewed beverages in a measured and controlled way to enhance the flavor, color and clarity of the finished product. The Objects and Advantages are:
i. Pressurized for controlled measured filtration process
ii. Continuous Loop processing
iii. Small, efficient and affordable for small Distillers and Brewers
iv. Tasting and Visual Test station for control during the process
v. Easy exchange of Carbon media for different product filtration and results
vi. Carbon capacity control during processing
vii. Stand alone unit to free up distilling and brewing equipment during this filtration process
viii. Filtration process allows for different end products from the same filtration process based on varied time of filtration.

### d. BRIEF DESCRIPTION OF THE DRAWINGS

The following drawings illustrate the components used in this process. Each component is identified in the drawing and is described in the corresponding numbered sheet below.

FIG. 1—The pressurized carbon loop process with tank, Closed process
1. Pump—Air actuated Diaphragm Explosion Proof
2. Sediment Filter—5 micron Post Filter
3. Tank—Stainless Steel Conical bottom Mixing
4. View Tube/Flow Meter—Glass view, Gallon Per Minute
5. Tank Testing/Tasting Station valve
6. Initial Carbon Filtration container
7. Secondary Carbon Filtration container
8. Final Carbon Filtration container
9. ½″ Ball Valve open to regulate process flow
10. ½″ Ball Valve filter by pass, filter
11. ½″ Ball Valve by pass, filter
12. ½″ Ball Valve by pass, filter
13. ½″ Ball Valve filter, by pass filter
14. ½″ Ball Valve process shut down
15. ½″ Ball Valve drain and clean
16. ½″ Ball Valve Tank shut down
17. 1½″×½″ Stainless Steel Tri Clover clamp
18. Tank Thermometer
19. ½″ Copper Pipe Type L
20. ½″ Copper 90 degree Type L connectors
21. ½″ Copper Tee Type L connectors
22. 6″ Stainless Steel Tri Clover clamp

FIG. 2—Open System Process. FIG. 1 minus Tank (3). Numbers in FIG. 2 are the same as FIG. 1. Inlet (17) inflow and exists outflow (17) to recycle.

FIG. 3—Detail of Carbon Containers (6, 7, 8) internal filter elements
23. 6″×1½″ Reducer
24. 1½″ Screened Gasket 100 Micron
25. 6″ screened Silicone Gasket 1000 Micron
26. Tri Clover clamp FIP fitting

FIG. 4—Mounting Frame makes process mobile on stand.
27. Uni-Strut Steel frame
28. L shaped Handles
29. Hinge bolt and folding Support Leg
30. Swivel Wheels
31. Welded Mounting brackets

### e. DESCRIPTION OF THE INVENTION

Filtration Loop is composed of existing components used in water purification and filtration operations. The combination of these components and their pressurization, creates this system of filtration and mixtures to produce the end product of distilled spirits and brewed beverages with varying tastes and alcohol levels after filtration. Pressure in the system allows for this process to be put on a loop for continuous running until the desired end product is achieved. Flexibility in using different carbon media allows for different taste results. Continuous loop filtration, allows for enhanced flavor, with varying color and clarity and varying levels of alcohol strength and tastes based on the time of filtration.

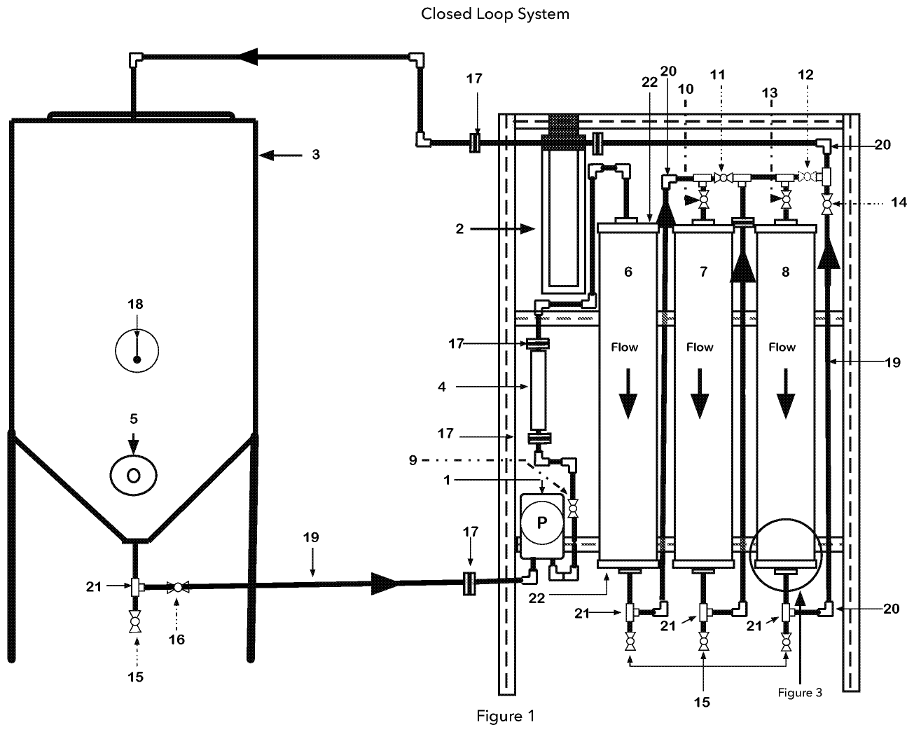

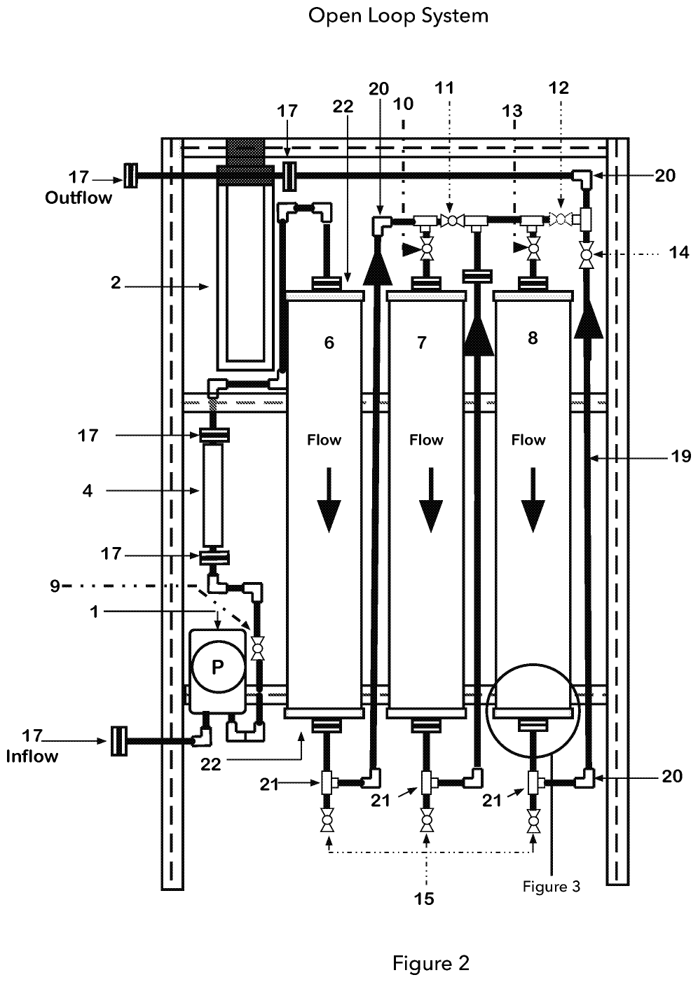

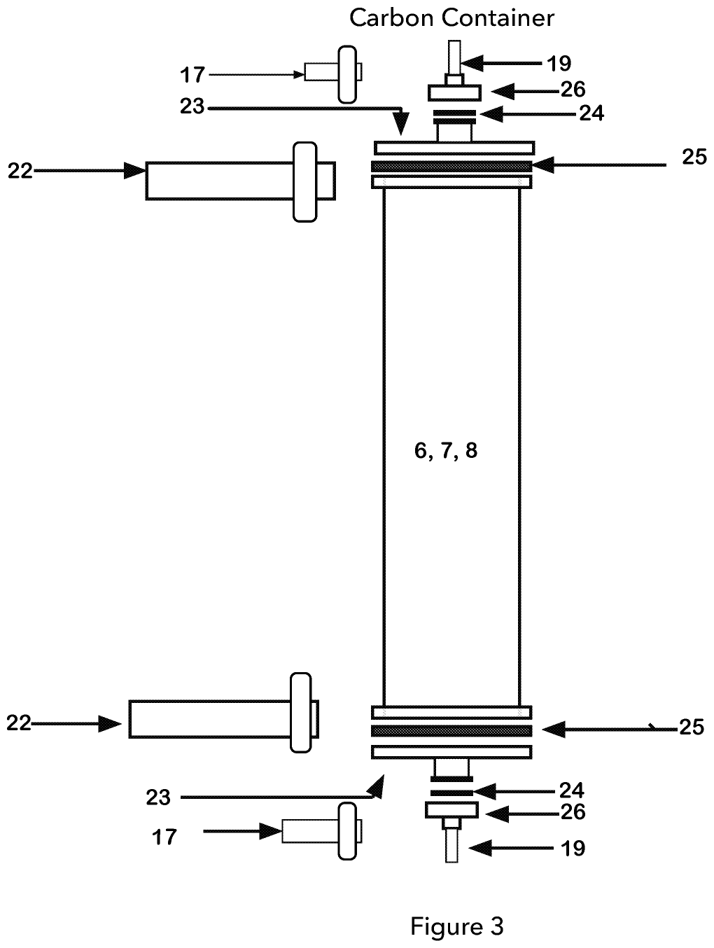

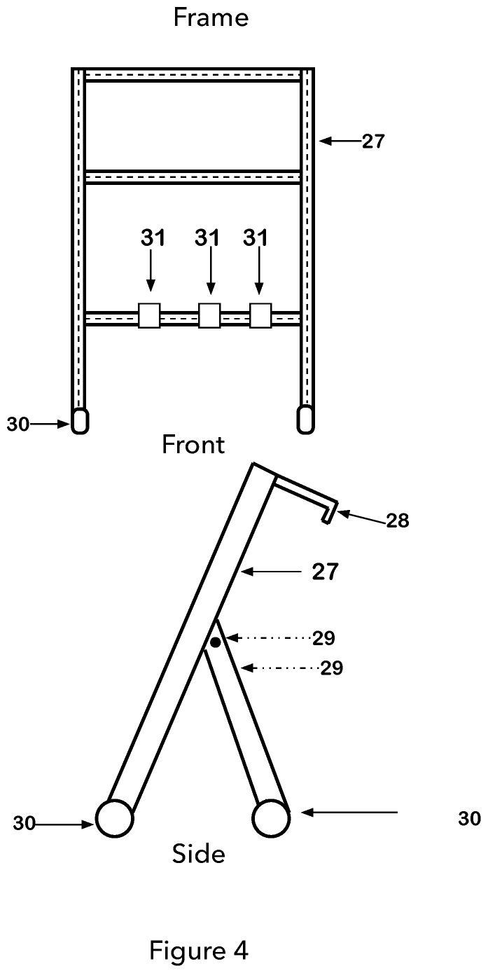

FIG. 1, Closed system, shows distilled spirits and brewed beverages are removed from production equipment and deposited into Tank (3). From the Tank (3), with ½′ Copper Pipe (Item 19) throughout, using ½″ Copper 90 degree connectors (20) throughout the process, product is sucked from the Tank (3) by the small pump (1). Product is then pumped through Ball Valve (9), into the View tube Flow Meter (4) into the initial Carbon Filter Container (6). Product leaves (6) and is routed to Tank (3) when ball valves (11 and 12)) are open and ball valves (10 and 13)) are closed. For added capacity, Carbon containers (6) and (7) are filtering when ball valve (10) is open and ball valve (11) is closed. Carbon containers (6, 7 and 8) are filtering when ball valves (11 and 12) are closed and ball valves (10 and 13) are open. After filtering, product flows thru Ball Valve Shut Down (14) through Sediment Filter (2), to Tank (3) to complete the loop, where the batch of product continues filtration loops to reduce the alcohol content, and achieves clarity, color and taste to desired levels. Color of the product is monitored with the View tube (4). Product is monitored using samples from the Testing/Tasting valve (5) on the Tank (3). Carbon filtration continues through the carbon filtration containers with pressurized loops. The Flow meter (4) measures the volume of product being processed, during a loop, through the system. Flow rates for the process are controlled by feathering ball valve (9). Temperatures are measured with the Thermometer (18) on the Tank (3). Ball Valves (15) are closed during operation. Ball Valves (15) are open when draining system or cleaning Carbon Containers (6, 7, 8) and the Tank (3). Ball Valve (16) is open during the filtration process and closed for Tank cleaning and draining. Stainless Steel Tri Clover Clamps are used to join components to the copper pipe for easy replacement and cleaning. ½″ Copper Tee connector (21) attaches the pipe with Ball Value (15) for cleaning the system tank (3) and Carbon containers (6, 7, 8). FIG. 2, Open system, is the Closed system minus the Tank (3). The process is the same as the Closed system but the product is taken directly from the producer's system into and through the loop process and back again. FIG. 3 shows inside detail of containers (6, 7, 8) where reducer (23) connects to copper pipe clamp (17) and fitting (26) with product moving through screen gasket (24) sealed to the container with silicone gasket (25) all clamped with Tri Clover clamp (22). This set-up is at the top and the bottom of containers (6, 7, 8) sealing the carbon and filtered product. FIG. 4 shows the frame of the unit using Uni-Strut (27) welded together in a square frame with handles (28). The fold out support leg (29) is bolt hinged to frame and wheels (30) attached for mobility. Open and closed systems are attached to the frame with bolts to welded brackets (31).

### f. CONCLUSION

This continuous loop process allows small Distiller's and Brewer's to efficiently filter their products, under pressure, many times, and reduce the alcohol levels, achieve clarity, color and taste results controlled by the time of filtration, with use of different carbon media and real time variable carbon capacity. Small gravity feed units existing today are not efficient, do not provide the flexibility of different carbon media or capacity and are limited by time in the number of cycles the carbon filtration can take place. In addition, the loop process allows a Distiller and Brewer to filter their product, then draw off a portion as done, to continue filtering the remaining product to produce different tasting spirits from the same batch. Alternative physical forms of the loop process can be produced, but the process of pressurized loop carbon filtration with multiple carbon media in varying capacities, are the unique aspects of this process. This process should not be limited to the physical item drawings only.

1. The claimed invention is a pressurized filtration loop process refining color, clarity and taste of spirits and brewed beverages, while reducing alcohol levels, in a measured way using continuing cycles, whereby desired quality levels are achieved.

2. The claimed invention allows for efficient exchange of carbon media during the filtration process whereby desired results are achieved by use of different carbon media types.

3. The claimed invention allows for immediate in process increase or decrease of filtration capacity whereby desired filtration time can be achieved.
